(19) United States
(12) Patent Application Publication
(10) Pub. No.: US 2007/0116813 A1
(43) Pub. Date: May 24, 2007

(54) Method for obtaining banana-derived products, in particular for liquefying banana to obtain pure juice

(75) Inventors: Nathalie Minatchy, Capesterre Belle Eau (FR); Jean-Louis Escudier, Armissan (FR); Michel Mikolajczak, Gruissan (FR)

Correspondence Address: EGBERT LAW OFFICES, 412 MAIN STREET, 7TH FLOOR, HOUSTON, TX, 77002, US

(73) Assignee: Institut National De La Recherche Agronomique, F-75338 Paris Ceddex 7 (FR)

(21) Appl. No.: 10/514,959

(22) PCT Filed: May 23, 2003
(86) PCT No.: PCT/FR03/01568

§ 371 Date: Jun. 6, 2005

(30) Foreign Application Priority Data
May 24, 2002 (FR) 0206545

(51) Int. Cl. A23L 2/02

(52) U.S. Cl. 426/489

(57) ABSTRACT

A method for liquefying bananas to obtain a pure juice includes: peeling the bananas, ensuring that the pulp is separated from the peel while preserving the integrity of the fruit, heating the pulp with oxygen-free steam, so as to enable the fruits to be blanched and an exudation juice to be obtained, cooling the pulp, reducing the pulp into a mash, subjecting the pulp mash to an enzymatic hydrolysis reaction, then pressing it to extract the juice therefrom, subjecting at least part of the exuded juice to reduced pressure so as to cool it and extracting therefrom a fraction of flavoring compounds by self-evaporation then condensing the water and of flavors contained therein, and mixing together the juice derived from pressing the pulp, the fraction of flavoring compounds and the cooled exuded juice to obtain the pure juice.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a method for obtaining products derived from bananas, in particular from liquefaction of bananas in order to obtain a pure juice.

### BACKGROUND OF THE INVENTION

Methods currently used to transform bananas do not permit to obtain 100% banana juices without adding water or sugar, but only nectars basically composed of banana pulp puree, water and sugar.

These drinks are obtained after peeling of the bananas, generally by submitting the pulp to a thermal treatment, followed by an abrupt putting under vacuum, eventually completed with an enzymatic reaction and pressing permitting to obtain a liquid fraction and a dry residue consisting of banana fibers.

Thus, patent FR 2 638 333, in particular, describes a method for extracting juice and flavorings from plant substrata such as in particular fruits, in which the raw material is first heated then rapidly cooled, preferably by condensation under vacuum.

This rapid putting under vacuum permits to disintegrate the raw material conducting to a gravitative juice flow in liquid phase, simultaneously causing the vaporization of a part of the aqueous phase of the substratum containing the main part of aromatic compounds that can be added, if necessary, to the juice flow, after condensation.

An improvement of this method is, besides, described in EP 0 727 948 of the same patent holder, referring to a device permitting to carry out the heating phase by means of vapors deriving from the raw material itself and not deriving from exogenous water, in order not to dilute the products and to avoid supplementary concentration steps.

Besides, U.S. Pat. No. 4,874,617 describes a method permitting to produce banana essences as well as un-flavored derivative liquids.

According to this document, the pulp and the parenchyma of the bananas are treated by heating by vapor, the mixture is submitted to reduced pressure, then enzymatic hydrolysis is performed in order to finally obtained a liquid fraction and a solid fraction.

The liquid fraction is then submitted to vacuum and evaporation of volatile compounds, in order to obtain the expected banana essence.

In fact, the success of banana-based drinks, of the nectar type, obtained through the current methods, is however greatly limited with the consumers who do not appreciate at all their thick consistency, and their lack of quenching qualities.

Besides, transformation of bananas into drinks or alimentary products having quality taste and aspect is extremely delicate, in particular because of the fragility of the fruit.

Actually, upon contact with air, bananas are rapidly subjected to unappetizing damaging the fruit and then getting in contact with their substratum.

In order to avoid this drawback, one should therefore imperatively transform intact fruits and work in an oxygen-free atmosphere.

Besides, in order to increase production rates and outputs, the classical methods generally assume to peel bananas mechanically, by means of machines that scrape away part of the skin in order to recover a maximum of pulp.

This causes not only astringent and unpleasant tastes in the finished products, but also creates a pulp puree excessively sensitive to browning, and therefore much more difficult to treat.

Besides, atmosphere-changing methods used in order to avoid contact with oxygen give no satisfactory results both from the point of view of the quality of the finished products and of their easy industrial application.

### BRIEF SUMMARY OF THE INVENTION

This invention, therefore, claims to provide a solution for these various drawbacks thanks to a banana-transformation method permitting to obtain products rich in taste, having a high nutritional quality, with a high output and using simple means.

Thus, this invention relates to a method for obtaining products derived from bananas, in particular from liquefaction of bananas in order to obtain a pure juice, in which;
the bananas are peeled, making sure to separate the pulp from the skin without damaging the integrity of the fruits,
the pulp is heated by vapor and without oxygen, in order to permit blanching the fruits and obtaining an exudation juice,
the pulp is cooled down,
the pulp is reduced to puree,
the banana pulp puree is subjected to an enzYmatic hydrolysis reaction, it is pressed in order to extract the juice from it.

characterized in that:
at least part of the exudation juice is subjected to reduced pressure in order to cool it down and extract from it a fraction of aromatic compounds by self-evaporation then condensation of the water and of the flavorings it contains, and
the juice obtained from the pressing of the pulp, the fraction of aromatic compounds and the cooled exudation juice are brought together in order to obtain said pure banana juice.

According to an additional feature of the method according to the invention, cooling and reducing the pulp to puree are obtained by passing it through an exchanger.

According to a variant of the method according to the invention, cooling and reducing the pulp to puree are obtained by putting it abruptly under reduced pressure, in order to perform a first extraction of aromatic fractions.

According to another particularly advantageous feature of the method according to the invention, one uses, for heating the banana pulp, the vapor obtained from at least part of the exudation juice produced by said pulp.

According to another characteristic of said method, heating the banana pulp is carried out in a vapor-saturated enclosure, for a period varying between 3 and 15 min.

In one embodiment of the method according to the invention, one also subjects abruptly the banana skins after heating to reduced pressure in order to extract from them another fraction of compounds having specific flavorings by means of self evaporation then condensation of the water they contain.

In this embodiment, the method is also characterized in that this fraction of aromatic compounds is added to the banana juice obtained by mixing the juice obtained from the pressing of the pulp, the fraction or fractions of aromatic compounds and the concentrated exudation juice.

According to another feature of the method according to the invention, in order to extract the aromatic compounds, the banana pulp, the exudation juice and/or the banana skins are subjected to a pressure varying between 30 and 500 mbars, preferably between 50 and 200 mbars.

Besides, according to an additional feature, the condensation of the aromatic compounds is performed at a temperature in the range of 0°.

According to another feature, enzymes with pectinase and hemicellulase activities are used for the enzymatic hydrolysis reaction.

According to another additional feature of the method according to the invention, ascorbic acid is added to the obtained banana juice, in order to avoid the browning of the latter upon contact with oxygen.

Besides, according to a possible embodiment, the method according to the invention is also characterized in that the excess of vapor used to heat the banana pulp is condensed, in order to collect the aromatic compounds it contains and to add them to the obtained banana juice.

### DETAILED DESCRIPTION OF THE INVENTION

This invention will be now be better understood when reading the following description, referring to non-restrictive exemplary embodiments.

This invention relates to a method permitting to transform bananas into various alimentary products, and in particular into pure juices.

The object of this invention is to permit obtaining banana juice having the characteristics of the original raw material, both in terms of color, odor, flavor, and nutritional value, in order to increase the commercial success of this type of products.

Besides, this method is based on the implementation of simple means permitting to save time and material, in order to improve outputs.

The first important phase of this method relates to the peeling of the fruits, chosen preferably ripe and spotted at a colorimetric stage of at least level 7, in order to optimize the organoleptic qualities of the products.

Bananas are actually peeled one by one, manually, and with precaution, in order to preserve the integrity of the fruit and to avoid damaging that can cause an untimely browning.

Once peeled, pulps can, of course, be conserved, if necessary, in an oxygen-free atmosphere, for example in carbon-dioxide saturated vats, or undergo the other stages of the method of transformation directly.

The transformation itself consists in heating afterwards the entire pulps by vapor, also oxygen-free, in a vapor-saturated heating chamber.

This permits both to blanch the banana pulps by denaturing the polyphenol oxidase enzymes responsible for the enzymatic browning of the polyphenols, and to obtain an exudation juice corresponding to a liquid fraction oozing from said heated pulps, and that can be re-used afterwards in the transformation chain.

Besides, heating time is adjustable, which permits to control the thermal treatment undergone by the raw material.

Thus, heating is performed by applying preferably a temperature ranging from 90 to 95° C. to the core of the fruits by any appropriate means, for 3 to 15 min.

However, in order to preserve as fully as possible the flavorings characteristic of bananas and not to dilute the juice, this method is advantageously based on using as preferable means the vapor deriving from the exudation juice of the pulps during this very heating phase.

Thus, said heating can, for example, start by means of water vapor introduced into heating chambers, and then be followed, as soon as possible, by vapor deriving from exudates, at least part of which is vaporized.

In this way, use of exogenous water not being part of the raw material is avoided, which could otherwise dilute the expected final products.

The method according to the invention provides for the heated material then to be transferred from the heating chamber into an expansion chamber, thanks to a volumetric pump with a leak-proof sleeve in order to avoid vapor leaks and vacuum breaking.

The banana pulp heated in advance is put under vacuum immediately, which causes self-evaporation of part of the water contained in the material as well as instantaneous cooling of the pulp.

Water vapor carries with it a first fraction of aromatic compounds, then it passes through a condenser and is finally collected in the form of aromatic condensates.

The expansion chamber used in the method according to the invention is, actually, connected to a vacuum device through a condenser cooled by a refrigerating fluid.

The nature of the obtained aromatic water depends on the value of the working pressure as well as on the condensation temperature.

Thus, operating at quite reduced pressure permits a good extraction of the volatile compounds, but their condensation temperature is also decreased.

These compounds are collected in the aromatic water only if the condenser is at a temperature low enough to retain them.

In the opposite case, they are sucked by the vacuum pump and released into the atmosphere.

The working pressure is the resultant from a compromise between the extraction capacity and the condensation capacity.

Industrially, a vacuum between 30 and 500 mbars (preferably 50 and 200 mbars) can be applied depending on the characteristics of the product one would like to obtain.

This operation of putting under vacuum therefore permits to transform bananas without letting them get in contact with oxygen.

Besides, it has also the effect of de-aerating the banana pulp puree, and, therefore, removing possible traces of dissolved oxygen.

This short treatment on whole fruits therefore quite advantageously permits to eliminate the possibility of any browning, be it enzymatic or non enzymatic.

Besides, during this phase, heating, grinding the bananas and cooling the pulp puree are performed simultaneously, which permits to save a considerable amount of time.

It can also be contemplated to replace this operation of putting under vacuum by cooling in a heat exchanger preferably having a scraped surface, but in such case, aromatic fractions are not extracted.

Vapor escaping from the heating chamber can also be collected and sent to a condenser in order to collect volatile compounds eventually carried by this vapor.

According to this method, the banana pulp puree obtained after putting under vacuum or cooling in an exchanger is then transferred to a tank where it undergoes an enzymatic hydrolysis.

The above-mentioned enzymes have pectinase and hemicellulase activities and are available on the market.

Of course, any type of enzymes permitting to obtain an identical result could also be appropriate for the implementation of this method.

This hydrolysis permits to make the cells fragile and to facilitate the extraction of the juice.

Thus, outputs are improved and the juice has a lesser viscosity.

Besides, the walls of the plant cells have also been made fragile due to the abrupt evaporation of the water during the putting under vacuum, which also contributes to a better extraction of the juice.

After the enzymatic hydrolysis, the puree is finally pressed by any appropriate means, such as, for example, a package press.

This equipment permits, by pressing in thin layers, to reach considerable juice outputs (they can reach 80% of the weight of the puree), however the necessity of labour force and maintenance is increased.

Therefore, on industrial level, it would certainly be preferable to use more mechanized equipment, even though with lesser outputs.

According to this method, in order to preserve as much as possible the entirety of flavorings contained in the initial raw material, the exudation juice derived from the heating is also subjected to putting under vacuum in order to cool it down instantaneously, which causes evaporation of part of the volatile compounds that are condensed and that constitute a second fraction of aromatic compounds soluble in water.

At this level of the steps of the process, there are therefore several fractions derived from original bananas, viz. the juice obtained after the phase of pressing of the pulp puree, the first fraction of aromatic condensates derived from the putting under vacuum of said pulp, the second fraction of aromatic compounds deriving from exudates and the cooled exudation juice.

In order to obtain a banana juice having the expected gustative qualities, this method is based on mixing all these different fractions, which advantageously results into a product in which are collected most of the nutritious elements and aromatic compounds, with an output of approximately 80% compared to peeled bananas, the 20% loss being essentially comprised of fibers that have not been digested by the enzymatic treatment.

The latter can however be used as food filler after grinding, in particular in dietetic products, or in animal food, which permits to obtain an output of approximately 100%.

Another implementation of the method according to the invention is further based on recovering also the banana skins flavorings that have specific qualities and that can have specific technological applications.

To this end, after passing said banana skins through the heating chamber which permits to wash them by the condensation of the vapor and therefore to remove the residues of phytosanitary products used in agriculture, the latter are also subjected to reduced pressure in order to extract from them a third fraction of compounds having specific flavorings by self-evaporation then condensation of the water they contain.

Skin residues can also be used, after grinding, as animal food.

It can also be contemplated to recover the vapor escaping from the heating chamber in order to send it to a condenser for the purpose of extracting from it the aromatic volatile compounds it contains, in order to add them to the obtained banana juice.

According to another feature of this method, ascorbic acid is added to the collected final product in order to protect it as much as possible against contact with oxygen.

The method of the invention permits therefore to obtain 100% banana juices, clear or pulpous, stable, without adding water or sugars. These juices therefore have a higher nutritional quality than that of banana nectars, as well as very strong banana taste and flavoring.

Comparative analyses of the composition of fresh bananas and the juice obtained through the method of the invention have been made.

Compositions of both products are given in the attached table, and which represents the comparison of the nutritional value of fresh bananas and of the banana juice obtained.

Thus, it can be seen that the nutritional profile of fresh bananas is largely maintained in the banana juice obtained though the method according to the invention.

As regards the vitamins that are present in quite small quantities, it is more difficult to establish outputs taking into consideration the sensitivity of the dosage apparatuses.

Besides, though this method has been described in particular within the scope of banana juice production, it is quite conceivable to elaborate other products or to use the various fractions obtained for other applications.

Thus, the banana pulp puree obtained by this method can be used for the production of not only juices, but also jams, fruit jellies and other confectionery, or also of food products for children, sparkling drinks, vinegars, etc.

As to aromatic condensates, they can be frozen or concentrated depending on their intended use.

They reflect well the subtlety of the natural flavoring of fresh bananas, unlike synthetic flavorings available on the market, which have only one single aromatic trait.

They can be used in this state for the aromatization of alcohol-free drinks or for the fabrication of natural banana flavorings after concentration by any appropriate means.

It is also possible to produce a pulpous juice by adding to the final banana juice some banana pulp (set apart in advance after the step of putting under vacuum and refined under modified atmosphere in order to remove the seeds).

For gustative reasons, lemon juice can be added, and the whole is then passed through a high pressure homogenizer in order to break the small particles of banana pulp and put them in suspension.

This juice is then stabilized microbiologically and conditioned.

A pasteurization at 80° C. for 20 minutes can be advantageously used.

It is obvious that the use of HTST (High Temperature Short Time) methods can be nothing but beneficial to the organoleptic qualities of the products.

In order to obtain clear juices, the liquefaction product has to be clarified by any appropriate means. This juice is rich in proteins and in pectins. In order to clarify it, proteins should be denatured and precipitated. Here is a possible clarification method: the juice is heated to a temperature sufficient for the denaturation of proteins then it is centrifuged. Proteins denatured by the heat will precipitate dragging along pectins with them. Tangential filtration techniques (micro filtration, ultrafiltration) can be used in order to provide brightness to the juice. Microfiltration on a 0.2 μm membrane has been advantageously used in our case. Juices are then stabilized microbiologically, like the pulpous juices, and conditioned.

Finally, one can also contemplate the production of aerated juices, because clear juices are very sweet products that can seem to be heavy and not thirst-quenching. Aeration gives lightness and permits to preserve the 100% banana character.

It is performed on the juice itself, by adding, for example, a 2-3 g/l dose of carbon dioxide, which permits to provide lightness to the product and to modify its organoleptic characteristics in a quite agreeable way.

| | | | Output in |
|---|---|---|---|
| | | Liquefaction | compounds |
| | Fresh bananas in | product | permitted by the |
| | g/kg by default | in g/kg by default | method |
| Soluble dry | 211.5 | 193.15 | 91 |
| matter | | | |
| Glucose | 57.8 | 57.78 | 100 |
| Fructose | 54.4 | 45.19 | 83 |
| Saccharose | 70.7 | 54.35 | 77 |
| Total sugars | 183 | 157.41 | 86 |
| Potassium | 3.19 | 0.2889 | 90 |
| Magnesium | 0.252 | 0.211 | 84 |
| Calcium | 0.046 | 0.0426 | 93 |
| Phosphorus, | 0.187 | 0.181 | 97 |
| total | | | |
| Phosphates | 0.573 | 0.556 | 97 |
| Vitamin E | 0.33 mg/100 g | 0.19 mg/100 g | 56 |
| Vitamin B1 | <0.05 mg/100 g | <0.05 mg/100 g | |
| Vitamin B2 | <0.05 mg/100 g | <0.05 mg/100 g | |
| Vitamin B6 | 0.3 mg/100 g | 0.205 mg/100 g | 68 |
| Vitamin PP | 0.54 mg/100 g | 0.4 mg/100 g | 74 |
| Vitamin B5 | 0.26 mg/100 g | 0.12 mg/100 g | 46 |

1. Method for obtaining products derived from bananas, in particular from liquefaction of bananas in order to obtain a pure juice, said method comprising the steps of:
peeling bananas to separate pulp from skin without damaging integrity of said bananas;
heating said pulp by vapor and without oxygen, in order to permit blanching of bananas and obtaining of an exudation juice;
cooling down said pulp;
reducing said pulp to puree;
subjecting the banana pulp puree to an enzymatic hydrolysis reaction, and then pressing the puree in order to extract the juice from said puree;
subjecting at least part of the exudation juice to reduced pressure in order to cool down the juice and extracting, from the juice, a fraction of aromatic compounds by self-evaporation then condensation of water and of flavorings contained in the juice; and
bringing together the juice obtained from pressing the pulp, the fraction of aromatic compounds and the cooled exudation juice to obtain pure banana juice.

2. Method according to claim 1, wherein said steps of cooling down and reducing the pulp to puree are further comprised of passing the pulp through an exchanger.

3. Method according to claim 1, wherein said steps of cooling down and reducing the pulp to puree are further comprised of putting abruptly the pulp under reduced pressure to perform a first extraction of aromatic fractions.

4. Method according to claim 1, wherein said step of heating the banana pulp is comprised of using vapor obtained from at least part of the exudation juice produced by said pulp.

5. Method according to claim 1, wherein said step of heating the banana pulp is comprised of heating in an vapor-saturated enclosure, to obtain a temperature ranging from 90 to 95° C. at a core of the bananas for a period between 3 and 15 min.

6. Method according to claim 1, further comprising the step of subjecting abruptly banana skins to reduced pressure, after heating, in order to extract another fraction of compounds having specific flavorings by means of self-evaporation then condensation of the water and of the flavorings contained in the banana skins.

7. Method according to claim 1, further comprising the step of subjecting, in order to extract the aromatic compounds, the banana pulp, the exudation juice and/or the banana skins to a pressure between 30 and 500 mbars, preferably between 50 and 200 mbars.

8. Method according to claim 1, wherein the condensation of the aromatic compounds is performed at a temperature in the range of 0° C.

9. Method according to claim 1, wherein enzymes with pectinase and hemicellulase activities are used for the step of subjecting to an enzymatic hydrolysis reaction.

10. Method according to claim 1, further comprising the step of: adding ascorbic acid to the obtained banana juice in order to avoid the browning of the latter upon contact with oxygen.

11. Method according to claim 1, wherein the vapor used for heating the banana pulp is condensed to collect the aromatic compounds contained in the vapor and adding the compounds to the obtained banana juice.
